(19) United States
(12) Patent Application Publication
(10) Pub. No.: US 2022/0159952 A1
(43) Pub. Date: May 26, 2022

(54) BUFFERED SILVER COMPLEX BIOCIDE

(71) Applicant: Hamilton Sundstrand Corporation, Charlotte, NC (US)

(72) Inventors: Carol L. Metselaar, Vernon, CT (US); Barbara M. Peyton, Windsor, CT (US); John W. Steele, New Hartford, CT (US)

(21) Appl. No.: 17/670,698

(22) Filed: Feb. 14, 2022

Related U.S. Application Data
(62) Division of application No. 15/697,765, filed on Sep. 7, 2017, now abandoned.

(51) Int. Cl. A01N 37/36; A01N 59/16; A01N 25/02

(52) U.S. Cl. CPC A01N 37/36; A01N 25/02; A01N 59/16

(57) ABSTRACT

A method for producing a biocide includes, for an aqueous solution that has a silver complex, a silver concentration of 0.5 to 30 parts-per-million, and a pH that is less than 6, increasing the pH of the aqueous solution into a pH range of 6-10 by adding a pH buffer to the aqueous solution.

### CROSS-REFERENCE TO RELATED APPLICATION

The present disclosure is a divisional of U.S. patent application No. 15/697,765 filed Sep. 7, 2017.

### BACKGROUND

Silver is known and used in water as a biocide. As examples, cooling systems in a space station, a space vehicle, or a ground-based structure may use coolant water that contains silver ions that serve as a biocide.

### SUMMARY

A method for producing a biocide according to an example of the present disclosure includes, for an aqueous solution that has a silver complex and a pH that is below 6, increasing the pH of the aqueous solution into a pH range of 6-10 by adding a pH buffer to the aqueous solution.

In a further embodiment of any of the foregoing embodiments, the pH of the aqueous solution prior to adding the pH buffer is 3 or less.

In a further embodiment of any of the foregoing embodiments, the silver complex includes a silver atom in complex with an organic acid compound.

In a further embodiment of any of the foregoing embodiments, the silver complex includes a silver atom in complex with a citrate compound.

In a further embodiment of any of the foregoing embodiments, the aqueous solution after adding the pH buffer has a silver concentration of up to 30 parts-per-million.

In a further embodiment of any of the foregoing embodiments, the pH buffer is selected from the group consisting of carbonate, phosphate, glycine, hydroxide, and combinations thereof.

In a further embodiment of any of the foregoing embodiments, the pH buffer includes at least one of sodium carbonate or sodium bicarbonate.

In a further embodiment of any of the foregoing embodiments, the pH buffer is selected from the group consisting of tris, tricine, 3-morpholinopropanesulfonic acid, and combinations thereof.

In a further embodiment of any of the foregoing embodiments, adding the pH buffer includes adding at least two buffers selected from the group consisting of tris, tricine, 3-morpholinopropanesulfonic acid, carbonate, phosphate, glycine, hydroxide, and combinations thereof.

### DETAILED DESCRIPTION

Disclosed herein is an aqueous biocide that has extended stability in comparison to ionic silver biocide. As studied by the inventors, the silver ions in a typical ionic silver biocide are unstable. The silver ions can precipitate onto system components and hinder proper operation. The silver can also deposit onto metallic alloys used in such systems and foment corrosion of those alloys. Although there are other biocides aside from silver, silver is a particularly effective biocide. It would therefore be desirable to continue to use silver, but with greater stability in order to avoid or reduce precipitation and corrosion. In this regard, the aqueous biocide herein is designed to have better stability to address such concerns.

The aqueous biocide includes an aqueous solution that has a silver complex. A “complex” is a molecular entity that has a loose bonding association between two or more component entities. Here, the entities are a silver atom and an organic compound. The loose bonding in such a complex is weaker than a covalent bond but is strong enough to stabilize the silver against precipitation. The silver in an ionic silver biocide may precipitate over the course of several weeks or a month, thereby reducing the concentration of silver in the biocide. However, the silver in the silver complex remains bonded and the concentration thus remains substantially constant over the same time period.

The aqueous solution, which may also be considered to be a base or stock solution, has a low pH. For example, at relatively low concentrations of 30 parts-per-million (“ppm”) of silver, the base aqueous solution has a pH below 2. Even diluted forms of the base aqueous solution at 5 ppm and 0.5 ppm have pH from 2 to 3.

The stock aqueous solution with such low pH may be damaging to metallic alloys. For instance, at such low pH, the solution is likely to increase corrosion pitting potential of stainless steel and nickel-based alloys, which are alloys commonly used in cooling systems. Therefore, although the stock aqueous solution may be an effective biocide, it is impractical in stock form because of the potential debit to metal components.

In order to render the base aqueous solution useable in coolant systems and the like, particularly those that utilize metal alloys, a pH buffer is added. The pH buffer is provided in an amount that is effective to increase the pH into a range from approximately 6 to approximately 10. Below 6, the pH may still be low enough to prompt corrosion.

The pH buffer may be selected from tris (also known as tris hydroxymethyl aminomethane or 2-amino-2-hydroxymethylpropane-1,3-diol), tricine (also known as N-(2-hydroxy-1,1-bishydroxymethylethylglycine), 3-morpholinopropanesulfonic acid (sometimes known as MOPS), carbonate, phosphate, glycine, hydroxide, and combinations thereof. Mixtures of the pH buffers may also be used. Example mixtures may include, but are not limited to, carbonate/bicarbonate, phosphate/carbonate, or glycine/hydroxide.

In one further example, the pH buffer includes at least one carbonate. For instance, the pH buffer includes one or both of sodium carbonate (e.g., 0.1N NaHCO₃ aq.) and sodium bicarbonate (e.g., 0.1N Na2CO₃ aq.). In further examples, the pH buffer has a ratio, by weight, of sodium carbonate to sodium bicarbonate that is 1:1 up to 10:1. In further instances, the ratio is from 8:2 to 9:1.

As discussed briefly above, the silver complex of the aqueous biocide herein includes a silver atom and an organic compound. The concentration of silver in the final aqueous biocide may be up to 30 ppm, but may more typically be 5 ppm, 1 ppm, or even 0.5 ppm. In a further example, the silver complex includes a silver atom in complex with an organic acid compound. Citrate is one example. For instance, the silver complex is silver dihydrogen citrate, shown below.

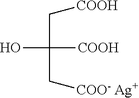

As will be appreciated, this disclosure is also applicable to a method for producing the aqueous biocide. As discussed above, the stock aqueous solution has a pH that is below 6 and is thus impractical for use with metal components. The method involves increasing the pH of the aqueous solution into a pH range of 6-10 by adding the pH buffer to the stock aqueous solution. The pH buffer may be combined with the stock aqueous solution using known chemistry techniques, but generally these can be combined by mixing together the two solutions under ambient conditions. The amount of pH buffer needed to increase the pH into the pH range of 6-10 can be determined using titration techniques, for example.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. A method for producing a biocide, the method comprising:
for an aqueous solution that has a silver complex, a silver concentration of 0.5 to 30 parts-per-million, and a pH that is less than 6, increasing the pH of the aqueous solution into a pH range of 6-10 by adding a pH buffer to the aqueous solution.

2. The method as recited in claim 1, wherein the silver complex includes a silver atom in complex with an organic acid compound.

3. The method as recited in claim 1, wherein the silver complex includes a silver atom in complex with a citrate compound.

4. The method as recited in claim 3, wherein the silver complex is dihydrogen citrate.

5. The method as recited in claim 1, wherein the pH buffer is selected from the group consisting of carbonate, phosphate, glycine, hydroxide, and combinations thereof.

6. The method as recited in claim 1, wherein the pH buffer includes at least one of sodium carbonate or sodium bicarbonate.

7. The method as recited in claim 1, wherein the pH buffer is selected from the group consisting of tris, tricine, 3-morpholinopropanesulfonic acid, and combinations thereof.

8. The method as recited in claim 1, wherein adding the pH buffer includes adding at least two buffers selected from tris, tricine, 3-morpholinopropanesulfonic acid, carbonate, phosphate, glycine, and hydroxide.

9. The method as recited in claim 1, wherein the pH buffer has a ratio, by weight, of sodium carbonate to sodium bicarbonate from 1:1 to 10:1.

10. The method as recited in claim 1, wherein the pH buffer has a ratio, by weight, of sodium carbonate to sodium bicarbonate from 8:2 to 9:1.

11. The method as recited in claim 1, wherein the adding the pH buffer to the aqueous solution is accomplished under ambient temperatures.

12. The method as recited in claim 1, wherein an amount of pH buffer necessary to achieve the pH range of 6-10 is determined using titration.

13. The method as recited in claim 1, wherein the aqueous solution is in contact with a metallic alloy that is subject to corrosion at a pH of 2 to 3.
